(19) United States
(12) Patent Application Publication
(10) Pub. No.: US 2024/0183735 A1
(43) Pub. Date: Jun. 6, 2024

(54) FORCE SENSING APPARATUS WITH BRIDGE PORTION

(71) Applicant: INDUSTRIAL TECHNOLOGY RESEARCH INSTITUTE, Hsinchu (TW)

(72) Inventors: Chien-Nan YEH, Tainan City (TW); Meng-Chiao TSAI, Taoyuan City (TW); Shih-Ting LIN, Tainan City (TW); Chao-Ta HUANG, Hsinchu City (TW)

(73) Assignee: INDUSTRIAL TECHNOLOGY RESEARCH INSTITUTE, Hsinchu (TW)

(21) Appl. No.: 18/140,513

(22) Filed: Apr. 27, 2023

(30) Foreign Application Priority Data
Dec. 5, 2022 (TW) 111146554

(51) Int. Cl. G01L 19/14; G01L 1/16

(52) U.S. Cl. CPC G01L 19/143; G01L 1/16

(57) ABSTRACT

A force sensing apparatus with bridge portion comprises a first case, a second case, and a force sensing module. The first case comprises a first annular portion, a first bridge portion, and an inner wall portion. The first bridge portion is connected to an outer periphery of the first annular portion. The inner wall portion is connected to an inner periphery of the first annular portion. The second case comprises a second annular portion, a second bridge portion, and an outer wall portion. The second bridge portion is connected to an inner periphery of the second annular portion. The outer wall portion is connected to an outer periphery of the second annular portion. A stiffness of the second annular portion along an axial direction is greater than a stiffness of the second bridge portion along the axial direction. The second case is disposed on the first case along the axial direction to form a space. The force sensing module is disposed in the space.

This non-provisional application claims priority under 35 U.S.C. § 119(a) on Patent Application No(s). 111146554 filed in Taiwan, R.O.C. on Dec. 5, 2022, the entire contents of which are hereby incorporated by reference.

### TECHNICAL FIELD

The disclosure relates to a force sensing apparatus, especially to a force sensing apparatus having high reliability.

### BACKGROUND

In the field of a conventional force sensing apparatus, there is a solution of using a strain gauge to measure a force applied to an object. When the strain gauge is used to perform a measurement, it needs to be adhered to the object by an adhesive. Therefore, an accuracy of the measurement performed by the strain gauge depends on the adhering techniques. The characteristic of the adhesive also varies with the environmental temperature. Thus, inaccurate values may be obtained by the strain gauge. Further, since the adhesive is located between the object and the strain gauge, a variation of the force endured by the object will be buffered by the adhesive, so that the strain gauge is unable to measure the force endured by the object in real time. That is, the strain gauge has low response speed and low sensitivity.

In recent years, in order to measure the force in real time, some force sensors use piezoelectric materials to measure the force. Although the piezoelectric material has advantages of high response speed and high sensitivity, it is fragile and thus such force sensors using the piezoelectric material has low reliability.

### SUMMARY

One embodiment of the disclosure provides a force sensing apparatus with a bridge portion including a first case, a second case, and a force sensing module. The first case includes a first annular portion, a first bridge portion, and an inner wall portion. The first bridge portion is connected to an outer periphery of the first annular portion. The inner wall portion is connected to an inner periphery of the first annular portion. The second case includes a second annular portion, a second bridge portion, and an outer wall portion. The second bridge portion is connected to an inner periphery of the second annular portion. The outer wall portion is connected to an outer periphery of the second annular portion. The second case is disposed on the first case along an axial direction to form a space. A stiffness of the second annular portion along the axial direction is greater than a stiffness of the second bridge portion along the axial direction. The force sensing module is disposed in the space.

Another embodiment of the disclosure provides a force sensing apparatus with a bridge portion including a first case, a second case, and a force sensing module. The first case includes a first annular portion, a first bridge portion, and an inner wall portion. The first bridge portion is connected to an outer periphery of the first annular portion. The inner wall portion is connected to an inner periphery of the first annular portion. The second case includes a second annular portion, a second bridge portion, and an outer wall portion. The second bridge portion is connected to an inner periphery of the second annular portion. The outer wall portion is connected to an outer periphery of the second annular portion. The second case is disposed on the first case along an axial direction to form a space. An outer recess is located at the first bridge portion. An inner recess is located at the second bridge portion. The force sensing module is disposed in the space.

### BRIEF DESCRIPTION OF THE DRAWINGS

FIG. 1 is a schematic perspective view of a force sensing apparatus with a bridge portion according to one embodiment of the disclosure;

FIG. 2 is a schematic perspective exploded view of the force sensing apparatus in FIG. 1;

FIG. 3 is a schematic front cross-sectional and partially enlarged view of the force sensing apparatus taken along line III-III in FIG. 1;

FIG. 4 is a schematic partially enlarged view of the force sensing apparatus in a range IV in FIG. 3;

FIG. 5 is a schematic partially enlarged view of the force sensing apparatus in a range V in FIG. 3;

FIG. 6 is a schematic front cross-sectional and partially enlarged view of a force sensing apparatus with a bridge portion according to another embodiment of the disclosure;

FIG. 7 is a schematic front cross-sectional and partially enlarged view of a force sensing apparatus with a bridge portion according to another embodiment of the disclosure; and

FIG. 8 is a schematic front cross-sectional and partially enlarged view of a force sensing apparatus with a bridge portion according to another embodiment of the disclosure.

### DETAILED DESCRIPTION

Features and advantages of embodiments of the disclosure are described in the following detailed description, it allows the person skilled in the art to understand the technical contents of the embodiments of the disclosure and implement them, and the person skilled in the art can easily comprehend the purposes of the advantages of the disclosure. The following embodiments are further illustrating the perspective of the disclosure, but not intending to limit the disclosure.

The drawings may not be drawn to actual size or scale, some exaggerations may be necessary in order to emphasize basic structural relationships, while some are simplified for clarity of understanding, but the disclosure is not limited thereto. It is allowed to have various adjustments under the spirit of the disclosure. In addition, the spatially relative terms, such as “up”, “top”, “above”, “down”, “low”, “left”, “right”, “front”, “rear”, and “back” and the like, may be used herein for ease of description to describe the relationship of one element or feature to another element(s) of feature(s) as illustrated in the drawings. It will be understood that the spatially relative terms are intended to encompass orientations of the element or feature but not intended to limit the disclosure.

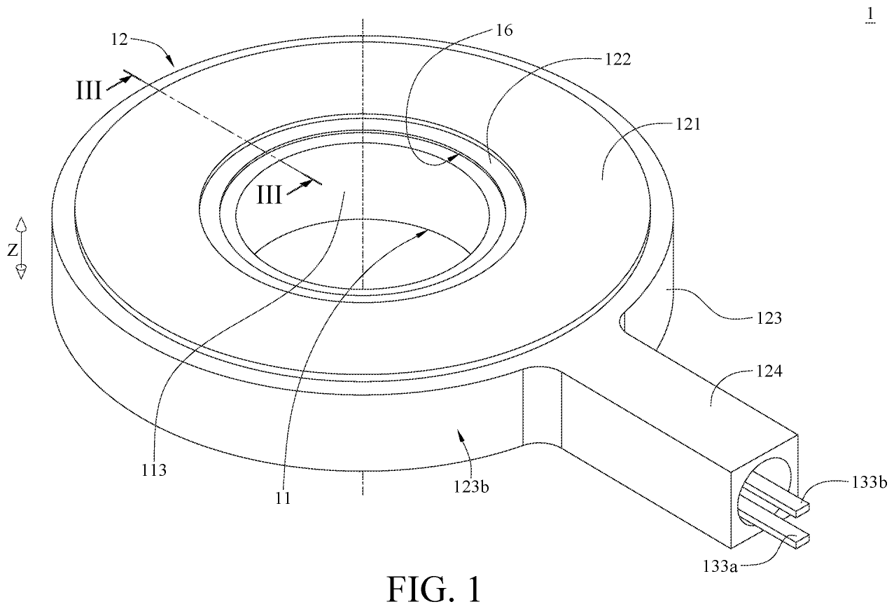

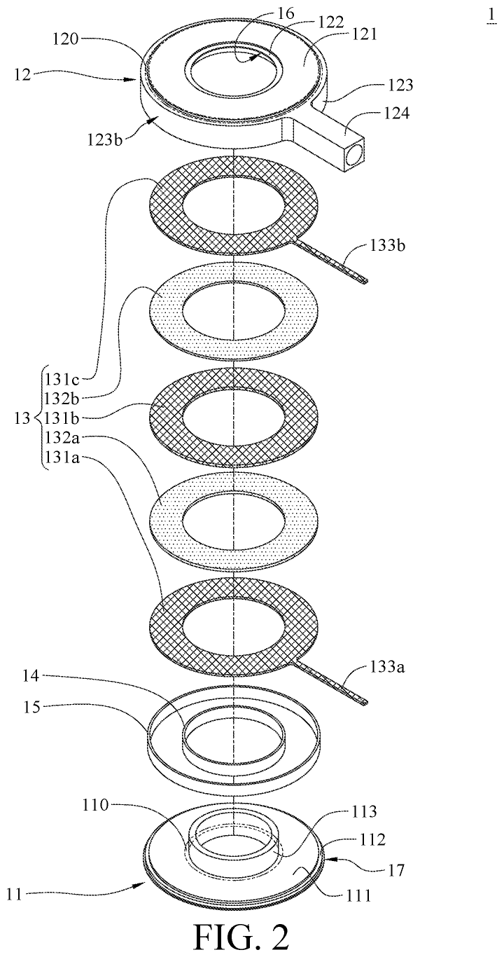

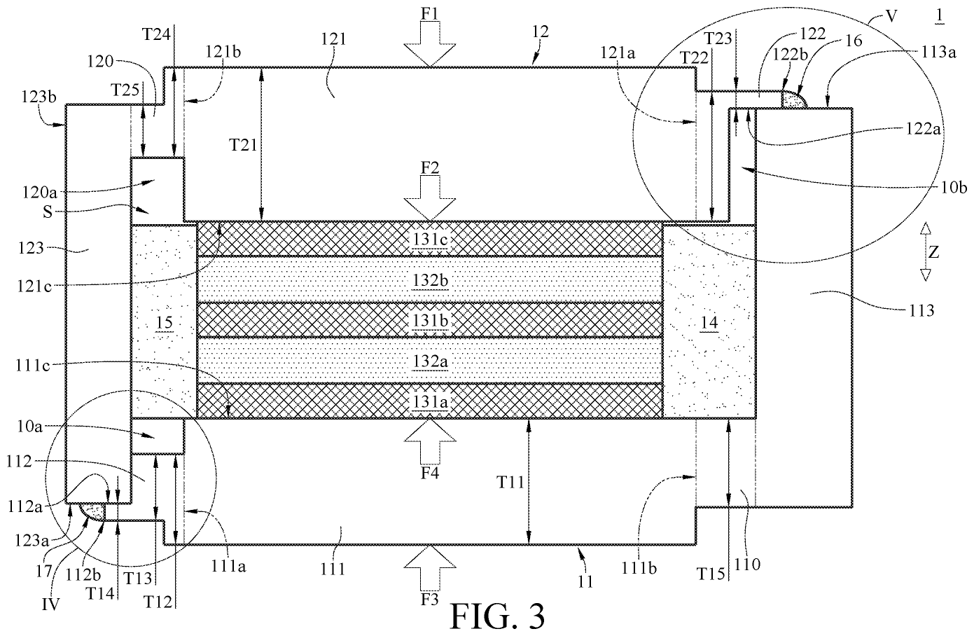

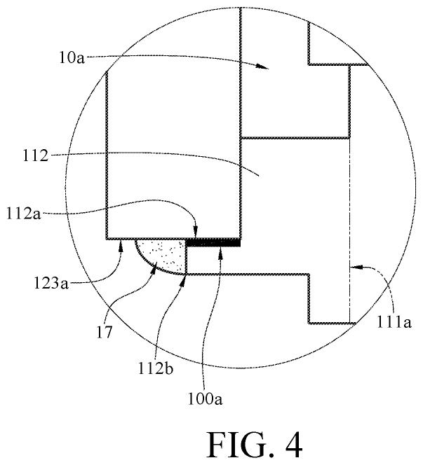

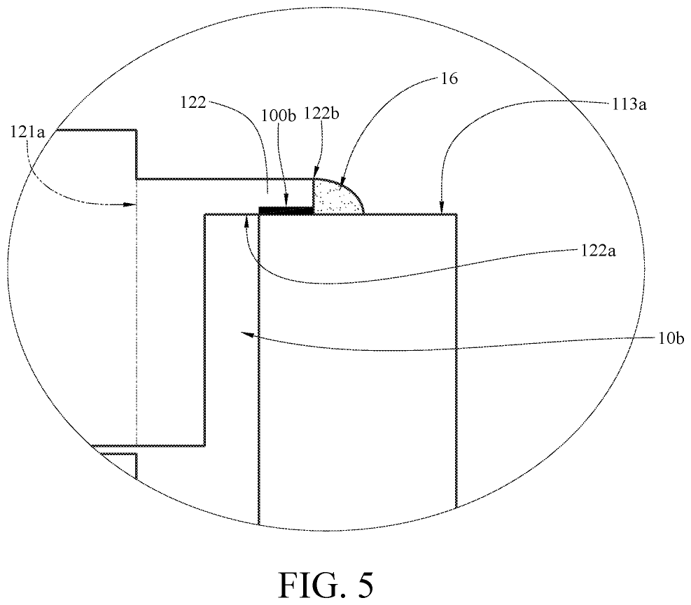

Please refer to FIG. 1 to FIG. 5. FIG. 1 is a schematic perspective view of a force sensing apparatus 1 with a bridge portion according to one embodiment of the disclosure. FIG. 2 is a schematic perspective exploded view of the force sensing apparatus 1 in FIG. 1. FIG. 3 is a schematic front cross-sectional and partially enlarged view of the force sensing apparatus 1 taken along line III-III in FIG. 1. FIG. 4 is a schematic partially enlarged view of the force sensing apparatus 1 in a range IV in FIG. 3. FIG. 5 is a schematic partially enlarged view of the force sensing apparatus 1 in a range V in FIG. 3. The force sensing apparatus 1 is configured for sensing a force along an axial direction Z.

As shown in FIG. 1 to FIG. 3, the force sensing apparatus 1 includes a first case 11, a second case 12, a force sensing module 13, an inner insulating layer 14, an outer insulating layer 15, an inner connecting component 16, and an outer connecting component 17.

The first case 11 includes a first connecting portion 110, a first annular portion 111, a first bridge portion 112 and an inner wall portion 113. The first bridge portion 112 is connected to an outer periphery 111a of the first annular portion 111. The inner wall portion 113 is connected to an inner periphery 111b of the first annular portion 111 via the first connecting portion 110.

The first annular portion 111 may have a uniform thickness T11. The first bridge portion 112 may have three portions (i.e. a portion with a thickness T12, a portion with a thickness T13 and a portion with a thickness T14) with different thicknesses. In the first bridge portion 112, the portion with the thickness T12 is connected to the outer periphery 111a of the first annular portion 111, the portion with the thickness T13 is connected to the portion with the thickness T12 and the portion with the thickness T14 is connected to the portion with the thickness T13 and is located farthest away from the first annular portion 111. The thickness T11 of the first annular portion 111 is greater than the thickness T12 of the first bridge portion 112, the thickness T12 is greater than the thickness T13 and the thickness T13 is greater than the thickness T14, but the disclosure is not limited thereto. Among the thickness T11, the thickness T12, the thickness T13 and the thickness T14, the thickness T11 should be the maximum value, and the relationship among the thickness T12, the thickness T13 and the thickness T14 is not necessarily limited thereto. Accordingly, a stiffness of the first annular portion 111 along the axial direction Z is greater than a stiffness of the first bridge portion 112 along the axial direction Z. In detail, when each of the first annular portion 111 and the first bridge portion 112 endures a force along the axial direction Z, an amount of deformation of the first bridge portion 112 along the axial direction Z may be greater than an amount of deformation of the first annular portion 111 along the axial direction Z.

In addition, the first connecting portion 110 has a thickness T15. The thickness T11 of the first annular portion 111 is greater than the thickness T15 of the first connecting portion 110. Accordingly, the stiffness of the first annular portion 111 along the axial direction Z is greater than a stiffness of the first connecting portion 110 along the axial direction Z. In detail, when each of the first annular portion 111 and the first connecting portion 110 endures a force along the axial direction Z, an amount of deformation of the first connecting portion 110 along the axial direction Z may be greater than an amount of deformation of the first annular portion 111 along the axial direction Z.

The second case 12 includes a second connecting portion 120, a second annular portion 121, a second bridge portion 122, an outer wall portion 123, and a wire accommodating portion 124. The second bridge portion 122 is connected to an inner periphery 121a of the second annular portion 121. The outer wall portion 123 is connected to an outer periphery 121b of the second annular portion 121 via the second connecting portion 120. The wire accommodating portion 124 is connected to an outer periphery 123b of the outer wall portion 123 (as shown in FIG. 1).

The second annular portion 121 may have a uniform thickness T21. The second bridge portion 122 may have two portions (i.e. a portion with a thickness T22 and a portion with a thickness T23) with different thicknesses. In the second bridge portion 122, the portion with the thickness T22 is connected to the inner periphery 121a of the second annular portion 121, and the portion with the thickness T23 is connected to the portion with the thickness T22 and is located farther away from the second annular portion 121. The thickness T21 of the second annular portion 121 is greater than the thickness T22 of the second bridge portion 122, and the thickness T22 is greater than the thickness T23, but the disclosure is not limited thereto. Among the thickness T21, the thickness T22, and the thickness T23, the thickness T21 should be the maximum value. And the relationship between the thickness T22 and the thickness T23 is not necessarily limited thereto. Accordingly, a stiffness of the second annular portion 121 along the axial direction Z is greater than a stiffness of the second bridge portion 122 along the axial direction Z. In detail, when each of the second annular portion 121 and the second bridge portion 122 endures a force along the axial direction Z, an amount of deformation of the second bridge portion 122 along the axial direction Z may be greater than an amount of deformation of the second annular portion 121 along the axial direction Z.

In addition, the second connecting portion 120 may have two portions (i.e. a portion with a thickness T24 and a portion with a thickness T25) with different thicknesses. In the second connecting portion 120, two ends of the portion with the thickness T24 are respectively connected to the outer periphery 121b of the second annular portion 121 and the portion with the thickness T25. Two ends of the portion with the thickness T25 are respectively connected to the portion with the thickness T24 and the outer wall portion 123. The thickness T21 of the second annular portion 121 is greater than the thickness T24 of the second connecting portion 120, and the thickness T24 is greater than the thickness T25, but the disclosure is not limited thereto. Among the thickness T21, the thickness T24 and the thickness T25, the thickness T21 should be the maximum value, and the relationship between the thickness T22 and the thickness T23 is not necessarily limited thereto. The outer wall portion 123, the second connecting portion 120, and the second annular portion 121 define a second case recess 120a. By a design of the second case recess 120a, the stiffness of the second annular portion 121 along the axial direction Z may be greater than a stiffness of the second connecting portion 120 along the axial direction Z. In detail, when each of the second annular portion 121 and the second connecting portion 120 endures a force along the axial direction Z, an amount of deformation of the second connecting portion 120 along the axial direction Z may be greater than an amount of deformation of the second annular portion 121 along the axial direction Z.

As shown in FIG. 3 to FIG. 5, the second case 12 is disposed on the first case 11 along the axial direction Z to form a space S. The detailed arrangement is: a top surface 112a of the portion with the thickness T14 of the first bridge portion 112 contacts a bottom surface 123a of the outer wall portion 123. A part where the first bridge portion 112 and the outer wall portion 123 are in contact with each other forms a first contact plane 100a (as shown by the widest line in FIG. 4). A top surface 113a of the inner wall portion 113 contacts a bottom surface 122a of the portion with the thickness T23 of the second bridge portion 122. A part where the second bridge portion 122 and the inner wall portion 113 are in contact with each other forms a second contact plane 100b (as shown by the widest line in FIG. 5).

At this time, an outer recess 10a is located at the first bridge portion 112. In detail, the outer wall portion 123 of the second case 12, the portion with the thickness T12 of the first bridge portion 112 of the first case 11, the portion with the thickness T13 of the first bridge portion 112 of the first case 11 and the first annular portion 111 of the first case 11 define the outer recess 10a. Additionally, an inner recess 10b is located at the second bridge portion 122. In detail, the inner wall portion 113 of the first case 11, the portion with the thickness T23 of the second bridge portion 122 of the second case 12 and the portion with the thickness T22 of the second bridge portion 122 of the second case 12 define the inner recess 10b. Moreover, the outer recess 10a, the inner recess 10b and the second case recess 120a are communicated with the space S.

The force sensing module 13 is disposed in the space S. The force sensing module 13 includes a plurality of electrically conductive layers 131a, 131b, and 131c and a plurality of piezoelectric layers 132a and 132b. The electrically conductive layers 131a, 131b, and 131c and the piezoelectric layers 132a and 132b are alternatively stacked along the axial direction Z. The electrically conductive layer 131c is located at a highest layer and the electrically conductive layer 131a is located at a lowest layer. In detail, the electrically conductive layer 131a, the piezoelectric layer 132a, the electrically conductive layer 131b, the piezoelectric layer 132b, and the electrically conductive layer 131c are sequentially stacked from the first annular portion 111 toward the second annular portion 121 along the axial direction Z. A wire 133a is connected to the electrically conductive layer 131a, and a wire 133b is connected to the electrically conductive layer 131c. The wire 133a and the wire 133b penetrate through the wire accommodating portion 124.

Sometimes, there are protruding structures on a surface of the first annular portion 111 or the second annular portion 121 because of the poor quality of the manufacturing process. When the first annular portion 111 or the second annular portion 121 endures a force along the axial direction Z, these protruding structures may pierce through the electrically conductive layers 131a and 131c. In one embodiment, a hardness of the electrically conductive layers 131a and 131c is greater than a hardness of the first annular portion 111 and greater than a hardness of the second annular portion 121. Accordingly, each of the electrically conductive layers 131a and 131c may be prevented from being pierced by the protruding structures of the first annular portion 111 or the second annular portion 121, thereby preventing the piezoelectric layers 132a and 132b from breaking.

The inner insulating layer 14 is disposed between the force sensing module 13 and the inner wall portion 113, and the inner insulating layer 14 may be in contact with the force sensing module 13 and the inner wall portion 113. The outer insulating layer 15 is disposed between the force sensing module 13 and the outer wall portion 123, and the outer insulating layer 15 may be in contact with the force sensing module 13 and the outer wall portion 123. The inner insulating layer 14 and the outer insulating layer 15 may prevent the piezoelectric layers 132a and 132b and the electrically conductive layers 131a, 131b, and 131c from being in direct contact with the inner wall portion 113 and the outer wall portion 123. Accordingly, the inner insulating layer 14 and the outer insulating layer 15 may prevent an electrical short circuit from being occurred between the piezoelectric layers 132a and 132b and the electrically conductive layers 131a, 131b, and 131c, and allow the force sensing module 13 to be fixed between the inner wall portion 113 and the outer wall portion 123.

The inner connecting component 16 connects an inner periphery (inner surface) 122b of the second bridge portion 122 of the second case 12 and the top surface 113a of the inner wall portion 113 of the first case 11. The inner connecting component 16 may be a soldering material or a welding material. The inner connecting component 16 allows the inner periphery 122b of the second bridge portion 122 and the top surface 113a of the inner wall portion 113 to be completely connected to each other through a soldering process or a welding process. In other words, the inner periphery 122b of the second bridge portion 122 and a corresponding part of the top surface 113a of the inner wall portion 113 may be completely connected to each other via the inner connecting component 16. The inner connecting component 16 may be in a completely annular shape. In another embodiment, the inner connecting component 16 may allow a part of the inner periphery 122b of the second bridge portion 122 and the corresponding part of the top surface 113a of the inner wall portion 113 to be connected to each other. It means that the inner periphery 122b of the second bridge portion 122 and the top surface 113a of the inner wall portion 113 are partially connected to each other. The second bridge portion 122 and the inner wall portion 113 only use the inner connecting component 16 as a connecting element. In other words, there is no additional connecting process such as bonding, gluing, soldering, or welding performed between a part of the inner periphery 122b of the second bridge portion 122 that is not connected to the inner connecting component 16 and a part of the top surface 113a of the inner wall portion 113 that is not connected to the inner connecting component 16. The inner connecting component 16 may be in a discontinuous annular shape similar to the shape of a dotted line.

It is noted that the inner connecting component 16 is not disposed on the second contact plane 100b between the second bridge portion 122 and the inner wall portion 113 (as shown in FIG. 5). Therefore, the bottom surface 122a of the portion with the thickness T23 of the second bridge portion 122 is merely in contact with the top surface 113a of the inner wall portion 113. When the second case 12 endures a force along the axial direction Z, the second annular portion 121 may move toward the electrically conductive layer 131c along the axial direction Z. At this time, a part of the bottom surface 122a of the second bridge portion 122 and a part of the top surface 113a of the inner wall portion 113 (i.e. a part located at the second contact plane 100b) might slide relative to each other. Accordingly, the stiffness of the second bridge portion 122 along the axial direction Z can be still reduced even after the second bridge portion 122 is welded.

The outer connecting component 17 connects an outer periphery (outer surface) 112b of the first bridge portion 112 of the first case 11 and the bottom surface 123a of the outer wall portion 123 of the second case 12. The outer connecting component 17 may be a soldering material or a welding material. The outer connecting component 17 allows the outer periphery 112b of the first bridge portion 112 and the bottom surface 123a of the outer wall portion 123 to be completely connected to each other through a soldering process or a welding process. In other words, the outer periphery 112b of the first bridge portion 112 and a corresponding part of the bottom surface 123a of the outer wall portion 123 may be completely connected to each other via the outer connecting component 17. At this time, the outer connecting component 17 may be in a completely annular shape. In another embodiment, the outer connecting component 17 may allow a part of the outer periphery 112b of the first bridge portion 112 and a part of the bottom surface 123a of the outer wall portion 123 to be connected to each other. It means that the outer periphery 112b of the first bridge portion 112 and the bottom surface 123a of the outer wall portion 123 are partially connected to each other. The first bridge portion 112 and the outer wall portion 123 only use the outer connecting component 17 as a connecting element. In other words, there is no additional connecting process such as bonding, gluing, soldering, or welding performed between a part of the outer periphery 112b of the first bridge portion 112 that is not connected to the outer connecting component 17 and a part of the bottom surface 123a of the outer wall portion 123 that is not connected to the outer connecting component 17. The outer connecting component 17 may be in a discontinuous annular shape similar to the shape of a dotted line.

It is noted that the outer connecting component 17 is not disposed on the first contact plane 100a between the first bridge portion 112 and the outer wall portion 123 (as shown in FIG. 4). Therefore, the portion with the thickness T13 and the portion with the thickness T14 of the first bridge portion 112 are merely in contact with the outer wall portion 123. When the first case 11 endures a force along the axial direction Z, the first annular portion 111 may move toward the electrically conductive layer 131a along the axial direction Z. At this time, the first bridge portion 112 and the outer wall portion 123 (i.e. a part located at the first contact plane 100a) might slide relative to each other. Accordingly, the stiffness of the first bridge portion 112 along the axial direction Z can be still reduced even after the first bridge portion 112 is welded.

In a conventional force sensing apparatus, the first bridge portion and the second bridge portion are not provided. The outer connecting component directly connects the first annular portion and the outer wall portion, and the inner connecting component directly connects the second annular portion and the inner wall portion. The inner connecting component and the outer connecting component are formed by a soldering material or a welding material. When an amount of the soldering material or welding material is excessive or insufficient, a stiffness of an upper annular portion of an upper case along an axial direction Z is not uniform. When the upper case endures a force along the axial direction Z, a certain part of the upper case deforms by a maximum amount and is in contact with a piezoelectric sheet of the force sensing apparatus. At this time, an area of the piezoelectric sheet in contact with the upper case cause a stress concentration on a certain place, thereby causing the piezoelectric sheet to break. Therefore, during the manufacture of the conventional force sensing apparatus, significant cost should be spent to perform an experiment several times to optimize the amount of the soldering material or the welding material to be used.

In contrast, in the force sensing apparatus 1 of this embodiment, a connecting manner of the inner connecting component 16 and a connecting manner of the outer connecting component 17 are unique as mentioned above. Therefore, the stiffness of the second annular portion 121 along the axial direction Z is not significantly affected by the amount of the inner connecting component 16 and the amount of the outer connecting component 17 to be used. In other words, when the amount of the inner connecting component 16 and the amount of the outer connecting component 17 to be used is excessive or insufficient, the whole second annular portion 121 is still in contact with the electrically conductive layer 131c in a manner parallel to the electrically conductive layer 131c after the second annular portion 121 endures a force along the axial direction Z. Therefore, stress concentration may not occur on the piezoelectric layer 132b, thereby preventing the piezoelectric layer 132b from breaking.

As shown in FIG. 3, when the force sensing apparatus 1 is used to sense a force F1 along the axial direction Z, the force F1 may be distributed on the force sensing module 13 via the second annular portion 121, so that a force F2 is applied by the second annular portion 121 to the force sensing module 13. At the same time, the first annular portion 111 distributes a reaction force F3 on the force sensing module 13, so that a force F4 is applied by the first annular portion 111 to the force sensing module 13. The piezoelectric layers 132a and 132b of the force sensing module 13 are pressed and thus generate an electrical signal. Such electrical signal may be transferred to a reading circuit (not shown) via the electrically conductive layers 131a, 131b, and 131c, the wire 133a, and the wire 133b, so as to estimate a magnitude of a force endured by the force sensing apparatus 1.

The stiffness of the second annular portion 121 along the axial direction Z is greater than the stiffness of the second connecting portion 120 along the axial direction Z and greater than the stiffness of the second bridge portion 122 along the axial direction Z. When the force sensing apparatus 1 endures the force F1 along the axial direction Z, an amount of deformation of the second connecting portion 120 along the axial direction Z and an amount of deformation of the second bridge portion 122 along the axial direction Z may both be greater than an amount of deformation of the second annular portion 121 along the axial direction Z. Therefore, a lower surface 121c of the second annular portion 121 may be in contact with the electrically conductive layer 131c in a manner substantially parallel to the electrically conductive layer 131c, so as to allow the force F2 able to be uniformly distributed on a whole upper surface of the electrically conductive layer 131c. Accordingly, stress concentration may be prevented from being occurred on the force sensing module 13, thereby preventing the piezoelectric layers 132a and 132b from breaking.

The stiffness of the first annular portion 111 along the axial direction Z is greater than the stiffness of the first connecting portion 110 along the axial direction Z and greater than the stiffness of the first bridge portion 112 along the axial direction Z. When the force sensing apparatus 1 endures the reaction force F3 of the force F1 along the axial direction Z, an amount of deformation of the first connecting portion 110 along the axial direction Z and an amount of deformation of the first bridge portion 112 along the axial direction Z may both be greater than an amount of deformation of the first annular portion 111 along the axial direction Z. Therefore, a upper surface 111c of the first annular portion 111 may be in contact with the electrically conductive layer 131a in a manner substantially parallel to the electrically conductive layer 131a, so as to allow the force F4 able to be uniformly distributed on a whole lower surface of the electrically conductive layer 131a. Accordingly, stress concentration may be prevented from being occurred on the force sensing module 13, thereby preventing the piezoelectric layers 132a and 132b from breaking.

Additionally, because a stiffness of each of the electrically conductive layers 131a, 131b, and 131c along the axial direction Z is greater than the stiffness of the first annular portion 111 along the axial direction Z and greater than the stiffness of the second annular portion 121 along the axial direction Z, the electrically conductive layers 131a, 131b, and 131c may not generate a greater amount of deformation when enduring the force along the axial direction Z. Accordingly, surfaces of the electrically conductive layers 131a, 131b, and 131c are in contact with the piezoelectric layers 132a and 132b in a manner substantially parallel to the piezoelectric layers 132a and 132b. Accordingly, the electrically conductive layers 131a, 131b, and 131c may uniformly distribute the forces F2 and F4 on the piezoelectric layers 132a and 132b along the axial direction Z. Accordingly, a concentrated stress may be prevented from being occurred on the piezoelectric layers 132a and 132b, thereby preventing the piezoelectric layers 132a and 132b from breaking.

In the aforementioned embodiment, be a certain design of the thicknesses, the first case 11 and the second case 12 respectively have specific stiffness values, but the disclosure is not limited thereto.

In other embodiment, the first case 11 may be formed by using materials with different Young's modulus, so as to allow different portions of the first case 11 to have different Young's modulus values. Accordingly, different portions of the first case 11 may have different stiffness values. For example, in the first case 11, a Young's modulus of a material of the first annular portion 111 is greater than a Young's modulus of a material of the first bridge portion 112, so as to allow the stiffness of the first annular portion 111 along the axial direction Z to be greater than the stiffness of the first bridge portion 112 along the axial direction Z. Further, the Young's modulus of the material of the first annular portion 111 is greater than a Young's modulus of a material of the first connecting portion 110, so as to allow the stiffness of the first annular portion 111 along the axial direction Z to be greater than the stiffness of the first connecting portion 110 along the axial direction Z.

In addition, the second case 12 may be formed by using materials with different Young's modulus, so as to allow different portions of the second case 12 to have different Young's modulus values. Accordingly, different portions of the second case 12 may have different stiffness values. For example, in the second case 12, a Young's modulus of a material of the second annular portion 121 is greater than a Young's modulus of a material of the second bridge portion 122, so as to allow the stiffness of the second annular portion 121 along the axial direction Z to be greater than the stiffness of the second bridge portion 122 along the axial direction Z. Further, the Young's modulus of the material of the second annular portion 121 is greater than a Young's modulus of a material of the second connecting portion 120, so as to allow the stiffness of the second annular portion 121 along the axial direction Z to be greater than the stiffness of the second connecting portion 120 along the axial direction Z.

In other embodiment, a certain portion of the first case 11 may have a specific stiffness by performing a heat treatment such as a quenching treatment or an annealing treatment on the certain portion of the first case 11. For example, steel or iron may be hardened by the quenching treatment or softened by the annealing treatment. A material of the first case 11 may be steel or iron. In the first case 11, an additional quenching treatment may be performed on the first annular portion 111, or an additional annealing treatment may be performed on the first bridge portion 112, so as to allow the stiffness of the first annular portion 111 along the axial direction Z to be greater than the stiffness of the first bridge portion 112 along the axial direction Z. Further, the additional quenching treatment may be performed on the first annular portion 111, or the additional annealing treatment may be performed on the first connecting portion 110, so as to allow the stiffness of the first annular portion 111 along the axial direction Z to be greater than the stiffness of the first connecting portion 110 along the axial direction Z.

In addition, a certain portion of the second case 12 may have a specific stiffness by performing a heat treatment such as a quenching treatment or an annealing treatment on the certain portion of the second case 12. For example, a material of the second case 12 may be steel or iron. In the second case 12, an additional quenching treatment may be performed on the second annular portion 121, or an additional annealing treatment may be performed on the second bridge portion 122, so as to allow the stiffness of the second annular portion 121 along the axial direction Z to be greater than the stiffness of the second bridge portion 122 along the axial direction Z. Further, the additional quenching treatment may be performed on the second annular portion 121, or the additional annealing treatment may be performed on the second connecting portion 120, so as to allow the stiffness of the second annular portion 121 along the axial direction Z to be greater than the stiffness of the second connecting portion 120 along the axial direction Z.

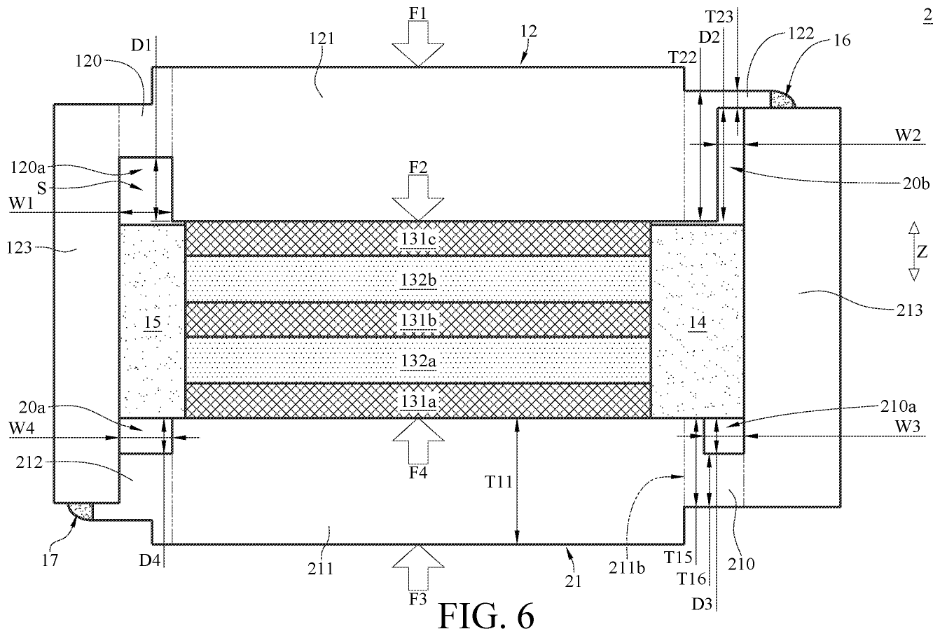

Please refer to FIG. 6. FIG. 6 is a schematic front cross-sectional and partially enlarged view of a force sensing apparatus 2 with a bridge portion according to another embodiment of the disclosure. In the force sensing apparatus 2 of this embodiment, a second case 12, electrically conductive layers 131a, 131b, and 131c, piezoelectric layers 132a and 132b, an inner insulating layer 14, an outer insulating layer 15, an inner connecting component 16 and an outer connecting component 17 are similar to those shown in FIG. 3. In this embodiment, the second case 12 includes the second connecting portion 120, the second annular portion 121, the second bridge portion 122, and the outer wall portion 123 and the second case recess 120a. Therefore, a detailed description of the elements similar to those of the force sensing apparatus 1 shown in FIG. 3 will be omitted. A first case 21 in this embodiment is mainly described in the following descriptions.

As shown in FIG. 6, in this embodiment, the first case 21 includes a first connecting portion 210, a first annular portion 211, a first bridge portion 212 and an inner wall portion 213. The inner wall portion 213 is connected to an inner periphery 211b of the first annular portion 211 via the first connecting portion 210.

The first annular portion 211 may have a uniform thickness T11. The first connecting portion 210 may have two portions (i.e. a portion with a thickness T15 and a portion with a thickness T16) with different thicknesses. In the first connecting portion 210, two ends of the portion with the thickness T15 are respectively connected to the inner periphery 211b of the first annular portion 211 and the portion with the thickness T16. Two ends of the portion with the thickness T16 are respectively connected to the portion with the thickness T15 and the inner wall portion 213. The thickness T11 of the first annular portion 211 is greater than the thickness T15 of the first connecting portion 210, and the thickness T15 is greater than the thickness T16, but the disclosure is not limited thereto. Among the thickness T11, the thickness T15, and the thickness T16, the thickness T11 should be the maximum value, and the relationship between the thickness T15 and the thickness T16 is not necessarily limited thereto. The inner wall portion 213, the portion with the thickness T16 of the first connecting portion 210, and the portion with the thickness T15 of the first connecting portion 210 define a first case recess 210a. By a design of the first case recess 210a, a stiffness of the first annular portion 211 along an axial direction Z may be allowed to be greater than a stiffness of the first connecting portion 210 along the axial direction Z. In detail, when each of the first annular portion 211 and the first connecting portion 210 endures a force along the axial direction Z, an amount of deformation of the first connecting portion 210 along the axial direction Z may be greater than an amount of deformation of the first annular portion 211 along the axial direction Z.

The second case 12 is disposed on the first case 21 along the axial direction Z to form a space S. At this time, the outer wall portion 123 of the second case 12, the first bridge portion 212 of the first case 21 and the first annular portion 211 of the first case 21 define an outer recess 20a. Additionally, the inner wall portion 213 of the first case 21, the portion with the thickness T23 of the second bridge portion 122 of the second case 12, and the portion with the thickness T22 of the second bridge portion 122 of the second case 12 define an inner recess 20b. Moreover, the outer recess 20a, the inner recess 20b, the first case recess 210a, and the second case recess 120a are communicated with the space S.

A stiffness of the first bridge portion 212 and a stiffness of the second bridge portion 122 along the axial direction Z may be respectively adjusted based on the outer recess 20a and the inner recess 20b. A stiffness of the second connecting portion 120 and a stiffness of the first connecting portion 210 along the axial direction Z may be respectively adjusted by the second case recess 120a and the first case recess 210a.

When a width W1 or a depth D1 of the second case recess 120a is increased, the stiffness of the second connecting portion 120 along the axial direction Z may be reduced. When a width W2 or a depth D2 of the inner recess 20b is increased, the stiffness of the second bridge portion 122 along the axial direction Z may be reduced. When the stiffness of the second connecting portion 120 and the stiffness of the second bridge portion 122 both are reduced, the second annular portion 121 may be in contact with a upper surface of the electrically conductive layer 131c in a manner parallel to the upper surface of the electrically conductive layer 131c when enduring a force F1 along the axial direction Z. Accordingly, a force F2 may be uniformly distributed on the upper surface of the electrically conductive layer 131c without stress concentration. In this way, when the electrically conductive layer 131c distributes the force F2 on the piezoelectric layers 132a and 132b, it does not easily cause the piezoelectric layer 132a and the piezoelectric layer 132b to break.

Similarly, when a width W3 or a depth D3 of the first case recess 210a is increased, the stiffness of the first connecting portion 210 along the axial direction Z may be reduced. When a width W4 or a depth D4 of the outer recess 20a is increased, the stiffness of the first bridge portion 212 along the axial direction Z may be reduced. When the stiffness of the first connecting portion 210 and the stiffness of the first bridge portion 212 both are reduced, the first annular portion 211 may be in contact with a lower surface of the electrically conductive layer 131a in a manner parallel to the lower surface of the electrically conductive layer 131a when enduring a reaction force F3 along the axial direction Z. Accordingly, a force F4 may be uniformly distributed on the lower surface of the electrically conductive layer 131a without stress concentration. In this way, when the electrically conductive layer 131a uniformly distributes the force F4 on the piezoelectric layers 132a and 132b, it does not easily cause the piezoelectric layers 132a and 132b to break.

If the second case recess 120a is not disposed at the second case 12, and the inner recess 20b is not formed when the second case 12 is disposed on the first case 21, the second annular portion 121 may frequently be in direct contact with the outer wall portion 123 or the inner wall portion 213 when the second case 12 endures the force F1 along the axial direction Z. At this time, the second annular portion 121 may be in contact with the upper surface of the electrically conductive layer 131c in a manner non-parallel to the upper surface of the electrically conductive layer 131c, thereby causing stress concentration. The concentrated stress may be not uniformly distributed on the piezoelectric layers 132a and 132b, thereby easily causing the piezoelectric layers 132a and 132b to break.

In contrast, in the force sensing apparatus 2 of this embodiment, the second case recess 120a may prevent the second annular portion 121 from being in direct contact with the outer wall portion 123 when the second annular portion 121 deforms, and the inner recess 20b may prevent the second annular portion 121 from being in direct contact with the inner wall portion 213 when the second annular portion 121 deforms. When the second case 12 endures the force F1 along the axial direction Z, the second annular portion 121 may be in contact with the upper surface of the electrically conductive layer 131c in a manner parallel to the upper surface of the electrically conductive layer 131c, so as to avoid stress concentration, thereby preventing the piezoelectric layers 132a and 132b from breaking.

Similarly, if the first case recess 210a is not disposed at the first case 21, and the outer recess 20a is not formed when the second case 12 is disposed on the first case 21, the first annular portion 211 may frequently be in direct contact with the inner wall portion 213 or the outer wall portion 123 when the first case 21 endures the reaction force F3 along the axial direction Z. At this time, the first annular portion 211 may be in contact with the lower surface of the electrically conductive layer 131a in a manner nonparallel to the lower surface of the electrically conductive layer 131a, thereby causing stress concentration. The concentrated stress may be not uniformly distributed on the piezoelectric layers 132a and 132b, thereby easily causing the piezoelectric layers 132a and 132b to break.

In contrast, in the force sensing apparatus 2 of this embodiment, the first case recess 210a may prevent the first annular portion 211 from being in direct contact with the inner wall portion 213 when the first annular portion 211 deforms, and the outer recess 20a may prevent the first annular portion 211 from being in direct contact with the outer wall portion 123 when the first annular portion 211 deforms. When the first case 21 endures the reaction force F3 along the axial direction Z, the first annular portion 211 may be in contact with the lower surface of the electrically conductive layer 131a in a manner parallel to the lower surface of the electrically conductive layer 131a, so as to avoid stress concentration, thereby preventing the piezoelectric layers 132a and 132b from breaking.

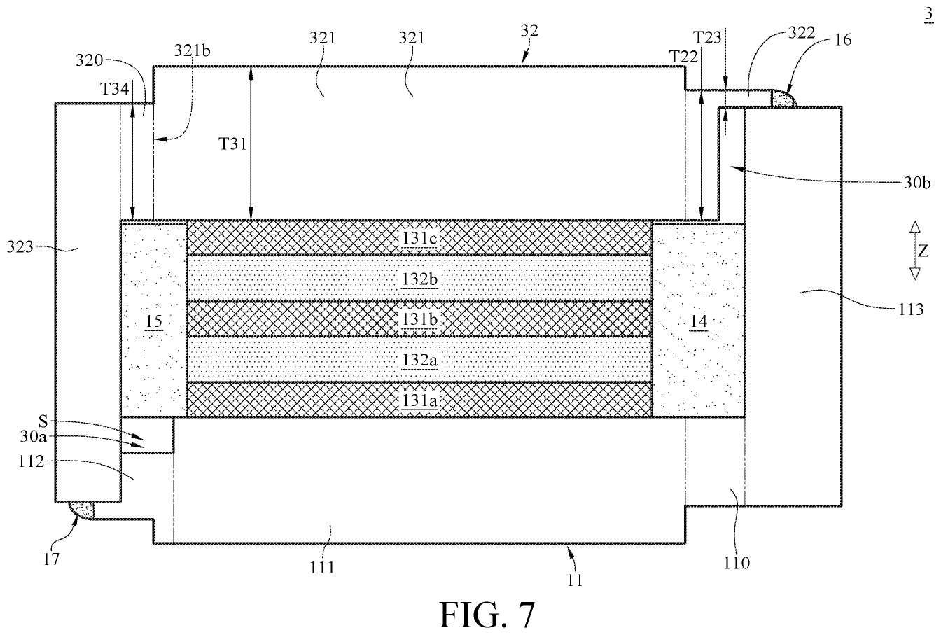

Please refer to FIG. 7. FIG. 7 is a schematic front cross-sectional and partially enlarged view of a force sensing apparatus 3 with a bridge portion according to another embodiment of the disclosure. In the force sensing apparatus 3 of this embodiment, a first case 11, electrically conductive layers 131a, 131b, and 131c, piezoelectric layers 132a and 132b, an inner insulating layer 14, an outer insulating layer 15, an inner connecting component 16, and an outer connecting component 17 are similar to those shown in FIG. 3. In this embodiment, the first case 11 includes the first connecting portion 110, the first annular portion 111, the first bridge portion 112 and the inner wall portion 113. Therefore, a detailed description of the elements similar to those of the force sensing apparatus 1 shown in FIG. 3 will be omitted. A second case 32 in this embodiment is mainly described in the following descriptions.

As shown in FIG. 7, in this embodiment, the second case 32 includes a second connecting portion 320, a second annular portion 321, a second bridge portion 322 and an outer wall portion 323. The outer wall portion 323 is connected to an outer periphery 321b of the second annular portion 321 via the second connecting portion 320.

The second annular portion 321 may have a uniform thickness T31. The second connecting portion 320 has a uniform thickness T34. The thickness T31 of the second annular portion 321 is greater than the thickness T34 of the second connecting portion 320. Accordingly, a stiffness of the second annular portion 321 along an axial direction Z is greater than a stiffness of the second connecting portion 320 along the axial direction Z. In detail, when each of the second annular portion 321 and the second connecting portion 320 endures a force along the axial direction Z, an amount of deformation of the second connecting portion 320 along the axial direction Z may be greater than an amount of deformation of the second annular portion 321 along the axial direction Z.

The second case 32 is disposed on the first case 11 along the axial direction Z to form a space S. The outer wall portion 323 of the second case 32, the first bridge portion 112 of the first case 11, and the first annular portion 111 of the first case 11 define an outer recess 30a. The inner wall portion 113 of the first case 11, a portion with a thickness T23 of the second bridge portion 322 of the second case 32 and a portion with a thickness T22 of the second bridge portion 322 of the second case 32 define an inner recess 30b. Moreover, the outer recess 30a and the inner recess 30b are communicated with the space S.

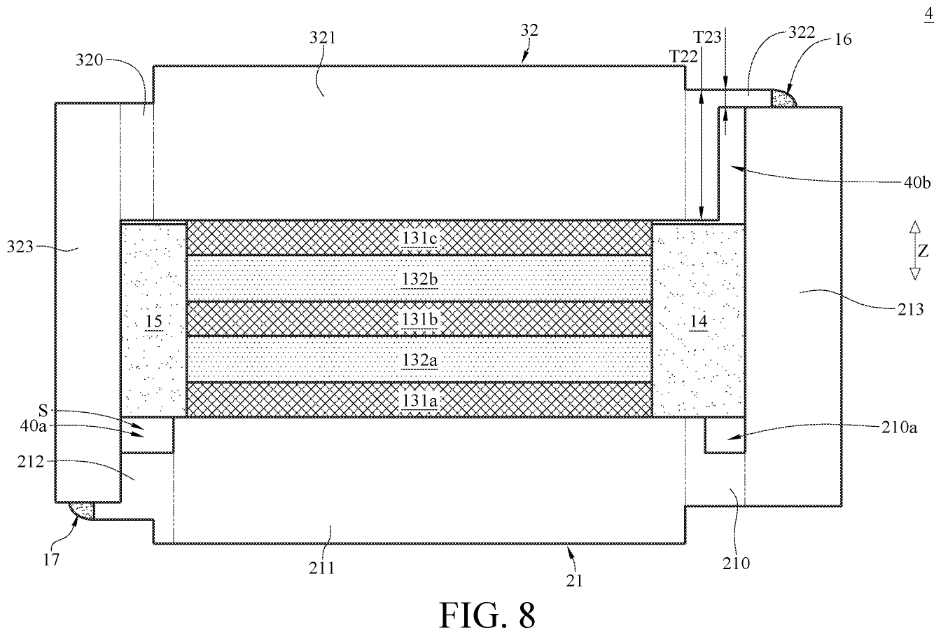

Please refer to FIG. 8. FIG. 8 is a schematic front cross-sectional and partially enlarged view of a force sensing apparatus 4 with a bridge portion according to another embodiment of the disclosure. In the force sensing apparatus 4 of this embodiment, electrically conductive layers 131a, 131b, and 131c, piezoelectric layers 132a and 132b, an inner insulating layer 14, an outer insulating layer 15, an inner connecting component 16 and an outer connecting component 17 are similar to those shown in FIG. 3. Moreover, the first case 21 is similar to the first case 21 shown in FIG. 6. The first case 21 includes the first connecting portion 210, the first annular portion 211, the first bridge portion 212, the inner wall portion 213, and the first case recess 210a. Further, the second case 32 is similar to the second case 32 shown in FIG. 7 and includes the second connecting portion 320, the second annular portion 321, the second bridge portion 322 and the outer wall portion 323.

As shown in FIG. 8, the second case 32 is disposed on the first case 21 along the axial direction Z to form a space S. The outer wall portion 323 of the second case 32, the first bridge portion 212 of the first case 21 and the first annular portion 211 of the first case 21 define an outer recess 40a. The inner wall portion 213 of the first case 21, the portion with the thickness T23 of the second bridge portion 322 of the second case 32 and the portion with the thickness T22 of the second bridge portion 322 of the second case 32 define an inner recess 40b. Moreover, the outer recess 40a, the inner recess 40b, and the first case recess 210a are communicated with the space S.

As discussed above, in the force sensing apparatus according to one embodiment of the disclosure, because of the inner recess located at the second bridge portion or the second case recess located at the second connecting portion, the stiffness of the second annular portion along the axial direction is allowed to be greater than the stiffness of the second bridge portion along the axial direction and greater than the stiffness of the second connecting portion along the axial direction. In this way, when the force sensing apparatus endures a force along the axial direction, the second annular portion can uniformly distribute the force on the force sensing module along the axial direction. Additionally, because of the outer recess located at the first bridge portion or the first case recess located at the first connecting portion, the stiffness of the first annular portion along the axial direction is allowed to be greater than the stiffness of the first bridge portion along the axial direction and greater than the stiffness of the first connecting portion along the axial direction. In this way, the first annular portion can uniformly distribute the reaction force of the force on the force sensing module along the axial direction. When the first annular portion or the second annular portion uniformly distribute the reaction force and the force on the force sensing module respectively, the stress concentration may be prevented from being occurred on the force sensing module, so as to prevent the piezoelectric elements in the force sensing module from breaking, thereby increasing a reliability of the force sensing apparatus. Additionally, since the force and the reaction force endured by the force sensing module both are uniform, abnormal measurement caused by stress concentration may be avoided, thereby improving the measurement accuracy of the force sensing apparatus.

Further, since the top surface of the first bridge portion contacts the bottom surface of the outer wall portion, and the top surface of the inner wall portion contacts the bottom surface of the second bridge portion, the stiffness of the first annular portion along the axial direction and the stiffness of the second annular portion along the axial direction are not significantly affected by the amount of the inner connecting component and the outer connecting component. Therefore, when enduring a force along the axial direction, the first annular portion and the second annular portion contact with the electrically conductive layer in a manner parallel to the electrically conductive layer, so that no stress concentration will occur on the piezoelectric layers, thereby preventing the piezoelectric layers from breaking.

Although the disclosure is disclosed in the foregoing embodiments, it is not intended to limit the disclosure. All variations and modifications made without departing from the spirit and scope of the disclosure fall within the scope of the disclosure. For the scope defined by the disclosure, please refer to the attached claims.

What is claimed is:

1. A force sensing apparatus with bridge portion, comprising:
a first case comprising:
a first annular portion;
a first bridge portion connected to an outer periphery of the first annular portion; and
an inner wall portion connected to an inner periphery of the first annular portion;
a second case comprising:
a second annular portion;
a second bridge portion connected to an inner periphery of the second annular portion; and
an outer wall portion connected to an outer periphery of the second annular portion;
wherein the second case disposed on the first case along an axial direction to form a space, a stiffness of the second annular portion along the axial direction is greater than a stiffness of the second bridge portion along the axial direction; and
a force sensing module disposed in the space.

2. The force sensing apparatus with bridge portion according to claim 1, wherein a top surface of the first bridge portion contacts a bottom surface of the outer wall portion, and a top surface of the inner wall portion contacts a bottom surface of the second bridge portion.

3. The force sensing apparatus with bridge portion according to claim 1, wherein a stiffness of the first annular portion along the axial direction is greater than a stiffness of the first bridge portion along the axial direction.

4. The force sensing apparatus with bridge portion according to claim 3, wherein a thickness of the first annular portion is greater than a thickness of the first bridge portion.

5. The force sensing apparatus with bridge portion according to claim 3, wherein a Young's modulus of a material of the first annular portion along the axial direction is greater than a Young's modulus of a material of the first bridge portion along the axial direction, so as to allow the stiffness of the first annular portion along the axial direction to be greater than the stiffness of the first bridge portion along the axial direction.

6. The force sensing apparatus with bridge portion according to claim 1, wherein a thickness of the second annular portion is greater than a thickness of the second bridge portion.

7. The force sensing apparatus with bridge portion according to claim 1, wherein a Young's modulus of a material of the second annular portion along the axial direction is greater than a Young's modulus of a material of the second bridge portion along the axial direction, so as to allow the stiffness of the second annular portion along the axial direction to be greater than the stiffness of the second bridge portion along the axial direction.

8. The force sensing apparatus with bridge portion according to claim 1, wherein the second case further comprises a second connecting portion, the outer wall portion is connected to the outer periphery of the second annular portion via the second connecting portion, and the stiffness of the second annular portion along the axial direction is greater than a stiffness of the second connecting portion along the axial direction.

9. The force sensing apparatus with bridge portion according to claim 1, wherein the first case further comprises a first connecting portion, the inner wall portion is connected to the inner periphery of the first annular portion via the first connecting portion, and a stiffness of the first annular portion along the axial direction is greater than a stiffness of the first connecting portion along the axial direction.

10. The force sensing apparatus with bridge portion according to claim 1, wherein the force sensing module comprises a plurality of electrically conductive layers and a plurality of piezoelectric layers, the plurality of electrically conductive layers and the plurality of piezoelectric layers are alternatively stacked along the axial direction, one of the plurality of electrically conductive layers is located at a highest layer, and another one of the plurality of electrically conductive layers is located at a lowest layer.

11. The force sensing apparatus with bridge portion according to claim 10, wherein a hardness of each of the plurality of electrically conductive layers is greater than a hardness of the first annular portion and greater than a hardness of the second annular portion.

12. The force sensing apparatus with bridge portion according to claim 10, wherein a stiffness of each of the plurality of electrically conductive layers along the axial direction is greater than a stiffness of the first annular portion along the axial direction and greater than the stiffness of the second annular portion along the axial direction.

13. The force sensing apparatus with bridge portion according to claim 2, further comprising an inner connecting component, wherein the inner connecting component connects an inner periphery of the second bridge portion and the top surface of the inner wall portion.

14. The force sensing apparatus with bridge portion according to claim 13, wherein the inner connecting component allows the inner periphery of the second bridge portion and the top surface of the inner wall portion to be completely connected to each other.

15. The force sensing apparatus with bridge portion according to claim 13, wherein the inner connecting component allows the inner periphery of the second bridge portion and the top surface of the inner wall portion to be partially connected to each other.

16. The force sensing apparatus with bridge portion according to claim 13, wherein the inner connecting component is not disposed between the bottom surface of the second bridge portion and the top surface of the inner wall portion.

17. The force sensing apparatus with bridge portion according to claim 2, further comprising an outer connecting component, wherein the outer connecting component connects an outer periphery of the first bridge portion and the bottom surface of the outer wall portion.

18. The force sensing apparatus with bridge portion according to claim 17, wherein the outer connecting component allows the outer periphery of the first bridge portion and the bottom surface of the outer wall portion to be completely connected to each other.

19. The force sensing apparatus with bridge portion according to claim 17, wherein the outer connecting component allows the outer periphery of the first bridge portion and the bottom surface of the outer wall portion to be partially connected to each other.

20. The force sensing apparatus with bridge portion according to claim 17, wherein the outer connecting component is not disposed between the top surface of the first bridge portion and the bottom surface of the outer wall portion.

21. The force sensing apparatus with bridge portion according to claim 1, further comprising an inner insulating layer and an outer insulating layer, wherein the inner insulating layer is disposed between the force sensing module and the inner wall portion, and the outer insulating layer is disposed between the force sensing module and the outer wall portion.

22. A force sensing apparatus with bridge portion comprising:
a first case comprising:
a first annular portion;
a first bridge portion connected to an outer periphery of the first annular portion; and
an inner wall portion connected to an inner periphery of the first annular portion;
a second case comprising:
a second annular portion;
a second bridge portion connected to an inner periphery of the second annular portion; and
an outer wall portion connected to an outer periphery of the second annular portion;
wherein the second case disposed on the first case along an axial direction to form a space, an outer recess is located at the first bridge portion and an inner recess is located at the second bridge portion; and
a force sensing module disposed in the space.

23. The force sensing apparatus with bridge portion according to claim 22, wherein the outer wall portion, the first annular portion, and the first bridge portion define the outer recess.

24. The force sensing apparatus with bridge portion according to claim 22, wherein the inner wall portion and the second bridge portion define the inner recess.

25. The force sensing apparatus with bridge portion according to claim 22, wherein the second case further comprises a second connecting portion, the outer wall portion is connected to the outer periphery of the second annular portion via the second connecting portion, and the second annular portion, the second connecting portion, and the outer wall portion define a second case recess.

26. The force sensing apparatus with bridge portion according to claim 22, wherein the first case further comprises a first connecting portion, the inner wall portion is connected to the inner periphery of the first annular portion via the first connecting portion, and the first connecting portion and the inner wall portion define a first case recess.

27. The force sensing apparatus with bridge portion according to claim 22, wherein the force sensing module comprises a plurality of electrically conductive layers and a plurality of piezoelectric layers, the plurality of electrically conductive layers and the plurality of piezoelectric layers are alternatively stacked along the axial direction, one of the plurality of electrically conductive layers is located at a highest layer, and another one of the plurality of electrically conductive layers is located at a lowest layer.

28. The force sensing apparatus with bridge portion according to claim 22, further comprising an inner connecting component, wherein the inner connecting component connects an inner periphery of the second bridge portion and a top surface of the inner wall portion.

29. The force sensing apparatus with bridge portion according to claim 22, further comprising an outer connecting component, wherein the outer connecting component connects an outer periphery of the first bridge portion and a bottom surface of the outer wall portion.

30. The force sensing apparatus with bridge portion according to claim 22, further comprising an inner insulating layer and an outer insulating layer, wherein the inner insulating layer is disposed between the force sensing module and the inner wall portion, and the outer insulating layer is disposed between the force sensing module and the outer wall portion.
